(19) United States
(12) Patent Application Publication
(10) Pub. No.: US 2012/0009551 A1
(43) Pub. Date: Jan. 12, 2012

(54) CUES TO POSITIVELY INFLUENCE EATING HABITS

(75) Inventor: Michael D. Pinnisi, Ithaca, NY (US)

(73) Assignee: Cognitive Science LLC, Ithaca, NY (US)

(21) Appl. No.: 13/177,745

(22) Filed: Jul. 7, 2011

Related U.S. Application Data
(60) Provisional application No. 61/362,157, filed on Jul. 7, 2010.

(51) Int. Cl. G09B 19/00

(52) U.S. Cl. 434/127

(57) ABSTRACT

A method of influencing eating habits of an individual including indicating upon an item a message regarding food intake, and positioning the item within areas of food consumption, preparation, or storage. An apparatus for influencing eating habits of an individual includes an item that can be displayed for viewing by an individual, and a message indicator placed upon the item, the message indicator including text or graphics indicating a message regarding food intake.

### CROSS REFERENCE TO RELATED APPLICATIONS

This application claims priority to U.S. Provisional Patent Application No. 61/362,157, filed Jul. 7, 2010 which is incorporated herein by reference.

### TECHNICAL FIELD

This disclosure is generally related to influencing the choices made by individuals by introducing cues regarding eating.

### BACKGROUND

Food intake decisions that individuals make on a daily basis can be linked, in part, to habit and environmental cues. Environmental cues can include billboards, television advertisements, and other multimedia information suggesting that an individual consume a certain product or family of products. Other environmental cues can exist within the domain of the individual, such as a candy dish sitting on a desk in plain view or a bowl of fruit displayed in the middle of the dining room table. An individual can form eating habits based in part on such environmental cues. For example, an individual may develop a habit of drinking coffee each morning because coffee is available within a break room in the workplace, and the individual is greeted by the smell of coffee when entering the workplace each day. An individual may also develop a habit of eating a snack each day upon returning home from work because snacks are displayed within television advertisements viewed by the individual.

To lower weight and improve health, individuals may employ mechanisms to modify eating habits. For example, an individual may join a diet club which includes daily positive reinforcement messages delivered through email or text messaging. The candy bowl, in another example, may be replaced with a bowl of fruit to remind the individual to eat healthier snacks. These mechanisms can serve as a reminder to an individual who wants to make changes towards healthy eating habits.

### SUMMARY

In one general aspect, a method of influencing eating habits of an individual including indicating upon an item a message regarding food intake, and positioning the item within areas of food consumption, preparation, or storage.

Implementations can include one or more of the following features. For example, the indicating step includes presenting the message for influencing an individual's decision for selecting a food item. The indicating step includes presenting the message for influencing the individual to reduce portion size when selecting a food item. The indicating step includes presenting the message for influencing the individual to select a fruit or vegetable. The indicating step includes presenting the message for influencing the individual to serve the food in an area other than where the individual consumes the food.

In another general aspect, an apparatus for influencing eating habits of an individual includes an item that can be displayed for viewing by an individual, and a message indicator placed upon the item, the message indicator including text or graphics indicating a message regarding food intake.

Implementations can include one or more of the following features. For example, the item is one of a magnet, signage, utensil, trivet, pot holder, towel, oven mitt, or utensil rest. The message regarding food intake includes a message for influencing the individual's decision for selecting a food item. The message regarding food intake includes a message for influencing the individual to reduce portion size when selecting a food item. The message regarding food intake includes a message for influencing the individual to select a fruit or vegetable. The message regarding food intake includes a message for influencing the individual to serve food in an area other than where the individual consumes the food.

### DESCRIPTION OF DRAWINGS

FIG. 1A is an example oven mitt with a healthy eating message.

FIG. 1B is an example trivet with a healthy eating message.

FIG. 1C is an example spoon rest with a healthy eating message.

FIG. 1D is an example wall art with a healthy eating message.

FIG. 2 illustrates an example layout of multiple healthy eating messages within a stove area.

FIG. 3 illustrates an example layout of multiple healthy eating messages within a refrigerator area.

### DETAILED DESCRIPTION

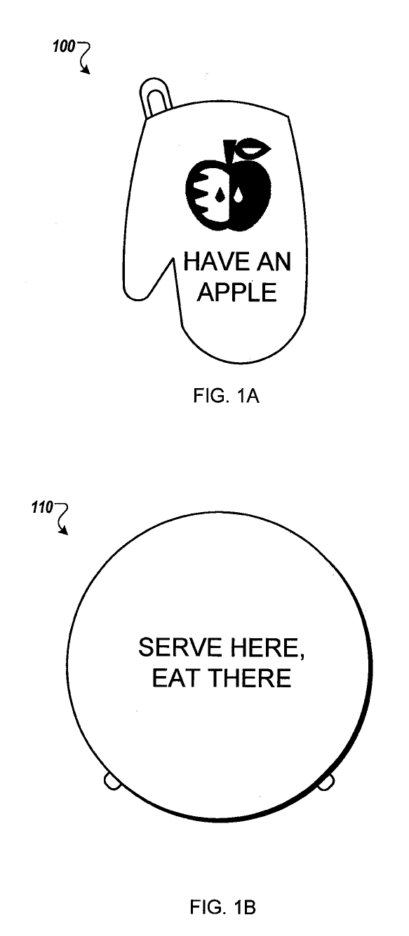

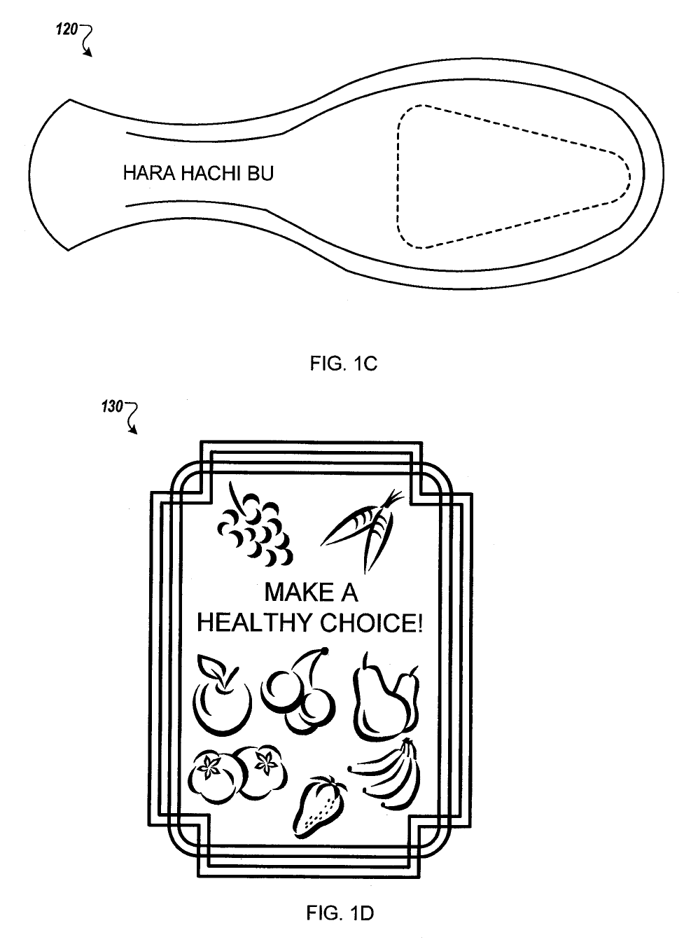

Fostering healthy eating habits includes making positive food choices. Environmental cues positioned in the area where food decisions are made can encourage an individual towards making healthier choices. Within the home, for example, food decisions are primarily made in the kitchen and dining areas. By introducing prominently displayed healthy eating reminders within the kitchen and dining areas, individuals can be influenced to make healthier eating choices. FIGS. 1A through 1D illustrate example, household items displaying healthy eating messages. These items can be found within the kitchen and dining areas of the average household. By replacing the currently used household item with a household item displaying a healthy eating message, an individual can benefit from the immediate environmental cue encouraging healthy eating habits at the time a food decision is made.

FIG. 1A is an example oven mitt 100 with a healthy eating message. The oven mitt 100 can be positioned within the kitchen or dining area of a household to encourage an individual to eat more fruit when snacking. The oven mitt 100 includes a graphic of an apple and the message “Have an Apple.” In other implementations, the oven mitt 100 can include the messages “have one today” alongside a graphic of an apple or other fruit, “snack on fruits and vegetables,” or “five a day” coupled with a graphic of one or more fruits and vegetables. Rather than an oven mitt, a message encouraging an individual to eat healthy snacks can be displayed upon another item commonly positioned within the area of the refrigerator or pantry, such as a pot holder, kitchen towel, or other kitchen textile.

FIG. 1B is an example trivet 110 with a healthy eating message. The trivet 110 can be positioned within the kitchen or dining area of a household to encourage an individual to practice portion control. The trivet 110 includes the message “Serve Here, Eat There.” This message can be used to influence an individual to serve food in an area removed from the eating area. For example, when a meal is plated within the kitchen and eaten in the dining room, an individual may be less likely to reach for a second helping than when the food is offered for service at the table. In other implementations, the trivet 110 can include the messages “keep out of reach for seconds,” “put leftovers away now,” or “single serving only.” Rather than a trivet, a message encouraging an individual to serve food in an area removed from the eating area can be displayed upon a serving spoon, kitchen timer, or other items commonly used within the area of the stove or microwave, in some examples.

FIG. 1C is an example spoon rest 120 with a healthy eating message. The spoon rest 120 can be positioned within the kitchen or dining area of a household to encourage an individual to eat only until satiated. The spoon rest 120 includes the message “Hara Hachi Bu,” an Okinawan cultural rule which means to eat only until 80% full. In daily practice, individuals commonly use environmental cues to determine when a meal is completed such as, in some examples, eating until everyone at the table has finished or until the plate is empty. These outside cues can encourage overeating. A message such as “hara hachi bu” can influence an individual to acknowledge internal cues to stop eating. In other implementations, the spoon rest 120 can include the messages “eat until nearly full,” “stop when no longer hungry,” or “listen to your stomach.” Rather than a spoon rest, a message encouraging appetite-led dining can be displayed upon a napkin holder, place mat, or water glass, in some examples.

FIG. 1D is an example of wall art 130 with a healthy eating message. The wall art 130 can be positioned within the kitchen or dining area of a household to encourage an individual, for example, to eat more produce. The wall art 130 includes the message “Make a Healthy Choice,” along with graphics of fruits and vegetables. In other implementations, the wall art 130 can include the messages “eat a rainbow each day” with graphics of multicolored fruits and vegetables, “give veggies top billing” with a graphic of a dinner plate filled mainly with vegetables and a small portion of protein, or “vegetables provide vitamins.”

Although various categories of messages (e.g., healthy snacking, reduced portions, and increased vegetable consumption) have been shown within FIGS. 1A through 1D in relation to various types of household items, any message designed to influence eating behavior can be displayed upon any type of household item. In some implementations, a single household item can include more than one message. For example, a two-sided potholder can display a first healthy eating message on the first side and a second healthy eating message on the opposite side. Other configurations are possible.

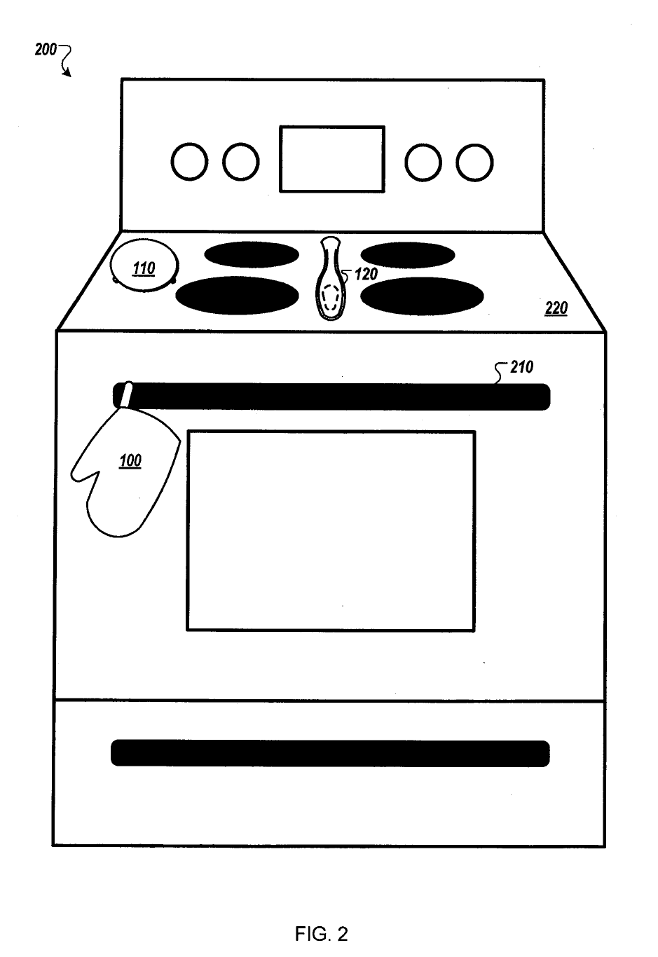

FIG. 2 illustrates an example layout of multiple healthy eating messages within a stove area 200 of a kitchen. An individual can arrange one or more household items including healthy eating messages in this or a similar manner to reinforce positive food choices at the point at which the individual is making food decisions. By positioning healthy eating messages within the stove area 200, for example, an individual can receive an immediate reminder of pursuing healthy eating habits when cooking or when simply moving through the kitchen area. The reminder can aid the individual in making positive food choices.

The household items described in relation to FIGS. 1A through 1C are positioned within the stove area 200. The oven mitt 100 is hanging from an oven door handle 210. The trivet 110 and the spoon rest 120 are placed upon a stove top 220. Any number of household items with positive food messages can be arranged in a similar fashion. An individual can use the arrangement of household items to support the breaking of bad eating habits (e.g., overeating or snacking on unhealthy foods) and/or the creation of good eating habits (e.g., consuming a larger quantity of healthy items, such as produce or fruits, or reducing portion size). Through repeated exposure to the messages indicated upon the household items, an individual can modify behavior patterns in food selection and consumption.

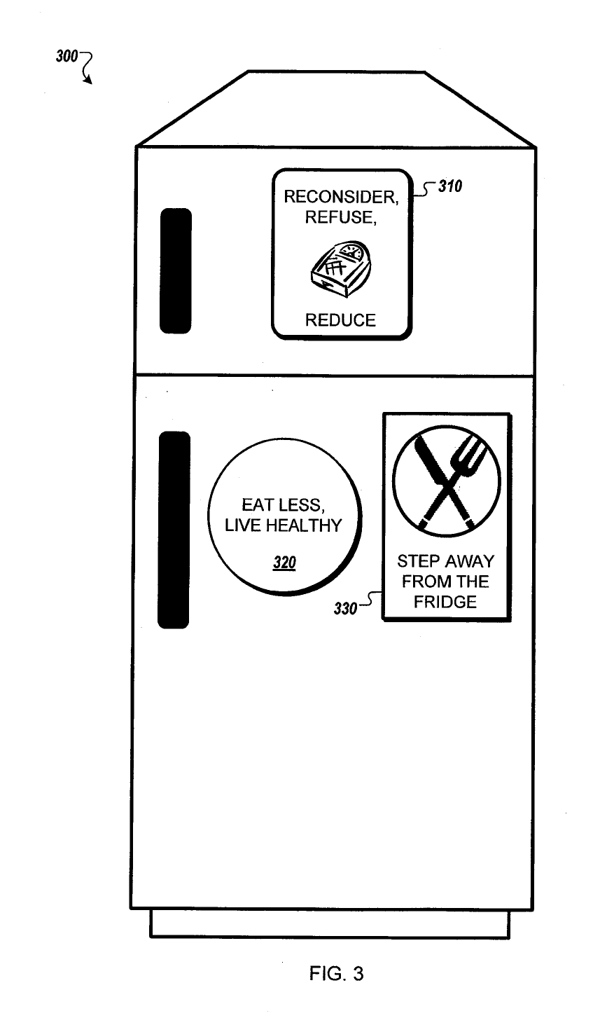

FIG. 3 illustrates an example layout of multiple healthy eating messages within a refrigerator area 300 of a kitchen. An individual can arrange one or more magnets including healthy eating messages in this or a similar manner to reinforce positive food choices at the point at which the individual is making food decisions. By positioning healthy eating messages within the refrigerator area 300, for example, an individual can receive an immediate reminder of pursuing healthy eating habits before opening the refrigerator door and making food choices. The reminder can aid the individual in making positive food decisions.

The refrigerator area 300 includes a first magnet 310, a second magnet 320, and a third magnet 330. Each magnet 310, 320, and 330 bears a message warning an individual to think twice before eating. By arranging the magnets 310, 320, and 330 in this manner, for example, an individual can be influenced to avoid impulse or habitual snacking. The first magnet 310 includes a message “Reconsider, Refuse, Reduce” along with a graphic of a bathroom scale. The second magnet 320 includes a message “Eat Less, Live Healthy.” The third magnet 330 includes a message “Step Away from the Fridge” along with a graphic of a crossed fork and knife. In other examples, the refrigerator area 300 can include magnets encouraging healthy snacking, reduced portions, and/or increased consumption of healthy items, such as fruits and vegetables.

While this description contains many specifics, these should not be construed as limitations on the scope of what is being claimed or of what may be claimed, but rather as descriptions of features specific to particular implementations. For example, although certain examples have been described in the context of a kitchen setting, healthy messages may also be provided in various other settings where food is consumed or prepared. Such examples include, but are not limited to, restaurants, school cafeterias, work break rooms, and other locations where food is stored, prepared, or consumed. Certain features that are described in this description in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations have been described. Other implementations are within the scope of the following claims.

1. (canceled)

2. A method of influencing eating habits of an individual, comprising:
indicating upon an item a message regarding food intake;
positioning the item within areas of food consumption, preparation, or storage; wherein indicating includes presenting the message for influencing an individual's decision for selecting a food item.

3. The method of claim 2, wherein indicating includes presenting the message for influencing the individual to reduce portion size when selecting a food item.

4. The method of claim 2, wherein indicating includes presenting the message for influencing the individual to select a fruit or vegetable.

5. The method of claim 2, wherein indicating includes presenting the message for influencing the individual to serve the food in an area other than where the individual consumes the food.

6. (canceled)

7. An apparatus for influencing eating habits of an individual, comprising:
an item that can be displayed for viewing by an individual; and
a message indicator placed upon the item, the message indicator including text or graphics indicating a message regarding food intake,
wherein the item is one of a magnet, signage, utensil, trivet, pot holder, towel, oven mitt, or utensil rest.

8. The apparatus of claim 7, wherein the message regarding food intake includes a message for influencing the individual's decision for selecting a food item.

9. The apparatus of claim 7, wherein the message regarding food intake includes a message for influencing the individual to reduce portion size when selecting a food item.

10. The apparatus of claim 7, wherein the message regarding food intake includes a message for influencing the individual to select a fruit or vegetable.

11. The apparatus of claim 7, wherein the message regarding food intake includes a message for influencing the individual to serve food in an area other than where the individual consumes the food.
